(19) United States
(12) Patent Application Publication
(10) Pub. No.: US 2006/0283673 A1
(43) Pub. Date: Dec. 21, 2006

(54) Brake assembly and additive

(76) Inventor: Robert A. Lamport, Centerville, OH (US)

Correspondence Address: DELPHI TECHNOLOGIES, INC., M/C 480-410-202, PO BOX 5052, TROY, MI, 48007, US

(21) Appl. No.: 11/153,719

(22) Filed: Jun. 15, 2005

(51) Int. Cl. F16D 69/00

(52) U.S. Cl. 188/251 R

(57) ABSTRACT

A brake assembly is provided that includes a wear-resistant rotor surface, or a surface prone to corrosion, wherein the surface is periodically coated with a corrosion inhibitor dispersed within the brake pad. A corrosion inhibitor, including a metal phosphate and an hydroxide encapsulated within an hydrophobic elastomer, is provided as an additive to a brake pad composition. The additive is mixed and molded, or otherwise formed and integrated with other constituents of a brake pad in the manufacture thereof. As the brake pad interfaces with the rotor upon brake application, the brake pad wears to impart a coating on an adjacent surface of the rotor. The heat of the rotor, and the properties of the corrosion inhibitor, combine to form metal phosphates that combined with hydrophobic properties of the brake pad prevent corrosion.

### FIELD OF THE INVENTION

The present invention relates to brake assemblies and to brake pads integrated therein. More specifically, the present invention relates to an improved brake pad containing corrosion preventative constituents that provides improved corrosion protection between the rotor/brake pad interface.

### BACKGROUND OF THE INVENTION

Virtually all disc brake rotors used for passenger vehicles are manufactured from cast iron. Several advantages of cast iron rotors include cost, relatively high thermal conductivity, ease of manufacture, and no thermal fatigue cracking under normal operating conditions. Nevertheless, the cast iron rotors readily corrode when exposed to moisture and typical environmental chemicals such as road salt.

The microstructure of cast iron contributes to its propensity to corrode. Carbon in excess of the solubility limit of iron precipitates into a secondary phase of graphite surrounded by a pearlite matrix. These graphite precipitates are typically flake or spherical in shape. Due to the large difference in electronegative potential between the graphite and the iron, each of the graphite precipitates and surrounding iron form miniature galvanic corrosion cells when the two are exposed to moisture. The situation is further accelerated in the presence of chloride ions such as those liberated from road salt in solution.

When corrosion of the rotor surface occurs, it results in a coefficient of friction that is both lower and less stable than cast iron. The corrosion product is typically also less dense than cast iron, and therefore locally increases thickness wherever it is present. Minimal variation in rotor thickness, 0.0005 inches for example, results in feedback through the pedal that can be felt by the operator and is also known as pulsation.

The initial Fe(OH)₃ corrosion product, will convert, particularly in the presence of heat, into either Fe₂O₃ or Fe₃O₄. Both are hard tenacious oxides that are not easily removed from the rotor surface without adding significant quantities of abrasive media to the friction material. Adding too much abrasive causes excessive rotor wear, even under normal braking conditions, and usually results in greater brake noise, i.e. brake squealing or groan.

Accordingly, the prevention of corrosion is highly desirable and may be accomplished by coating or painting with corrosion-resistant materials. Although effective to reduce corrosion, sacrificial corrosion protection coatings by themselves may not be suited to wear applications. For example, concerns have been identified when these coatings were used in an automotive braking application. To illustrate, when a zinc corrosion resistant coating is applied over an automotive front brake rotor, the standard brake lining comes into sliding contact with the coating. The coating is found to exhibit galling and/or the build-up of asperities (regions of accumulated material, high spots) over the wear surface that interferes with braking action. The melt point temperature of zinc is lower than the wear surface temperature at the pad/rotor interface. Asperities can induce unwanted vibration and audible noise from the braking system. Furthermore, these asperities can erode the surface of the brake lining as the number of revolutions of the rotor past the stationary lining increases.

Brake pads typically contain 10-25% porosity by design. This usually is indicative of a microstructure containing some, if not a majority of, open porosity. The porosity is good for pad compliance, reduced brake noise, and increased friction stability with respect to temperature and pressure, but bad for water absorption. Water absorbed by a brake pad significantly lowers the coefficient of friction until the water is evaporated off from repeated brake applies. This temporary loss of output is referred to as water fade and recovery. Any absorbed water in the rotor supplies the electrolyte needed for the occurrence of crevice corrosion between the pad and rotor. If the vehicle remains parked for extended periods of time under these conditions, the corrosion products (e.g. iron hydroxides and iron oxides) can wick into the pad porosity, solidify into a hard layer, and literally bond the pad to the now corroded rotor surface. Iron oxides are also less dense than the parent cast iron. Thus, the rotor thickness locally increases wherever corrosion occurs. This is most commonly observed directly beneath the brake pad, or around its outside perimeter, and is the cause of corrosion-induced brake pulsation. Depending on the quality of the coating, this approach may result in a coating that wears quickly thereby resulting in “lot rot” or corrosion of the rotors prior to selling the associated vehicle. Furthermore, coating the rotors and/or brake pads adds to the manufacturing cost and complexity.

Yet another concern involves the volatile organic compounds that are often attendant to the application of paints to the surface of components such as those usually found in automotive brake assemblies.

Accordingly, it would be an improvement in the art to provide a brake assembly that does not necessarily require a corrosion-resistant coating to inhibit rust and oxide formation.

### SUMMARY

In accordance with the present invention, a brake assembly having at least one surface predisposed to corrosion is provided. Brake pads or brake linings are formed in a conventional manner, by molding for example, wherein the composition of the material used to form the brake pad/lining contains at least one water soluble-phosphate dispersed therein. Other constituents may also be dispersed within the brake pad including alkali or alkaline earth metal hydroxides or oxides, and water-insoluble phosphates thereby improving the rust preventative properties and/or the friction properties of the brake pads.

In another aspect of the invention, the brake pad is designed to wear and impart a coating on the rotor whereby water-soluble phosphates are applied to the rotor at each application of the brakes. It will be appreciated that the water-soluble phosphate, once dissolved in local moisture present at the brake pad/rotor interface, preferably provides an alkaline solution thereby increasing the localized pH level and preventing the formation of galvanic circuits between the brake pad and the rotor. Furthermore, the phosphates of the present invention preferably combine with the metal to form metallic phosphates that when heated form a ceramic on the opposing surfaces of the rotor and the brake pad, thereby providing a barrier to galvanic circuit formation.

Stated another way, the present invention may be characterized by a brake pad containing an additive selected from water-soluble phosphates, and preferably alkaline earth or alkali metal phosphates, wherein the additive is added to other known constituents of a brake pad such as elastomeric materials, metal materials, stabilizers, friction components, and others, and mixtures thereof, during the molding or forming of the brake pad. The resultant brake pad has the additive dispersed within the brake pad to provide time released deposition of the phosphate at the rotor/brake pad interface and therefore on the adjacent surfaces of the rotor and the brake pad.

IN THE DRAWINGS

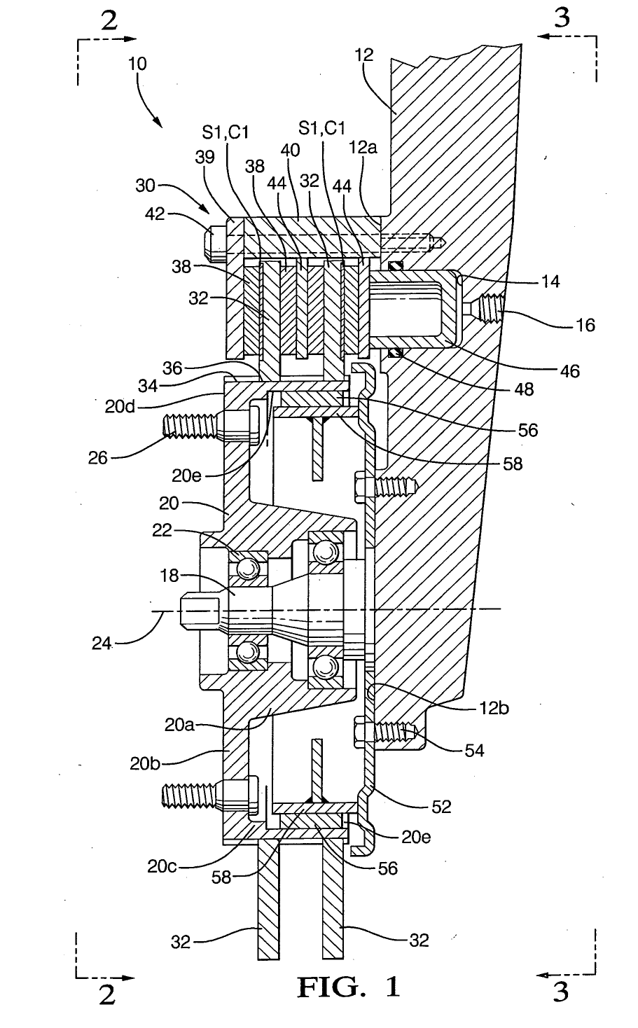

FIG. 1 is a vertical cross-sectional view taken through a first illustrative brake system;

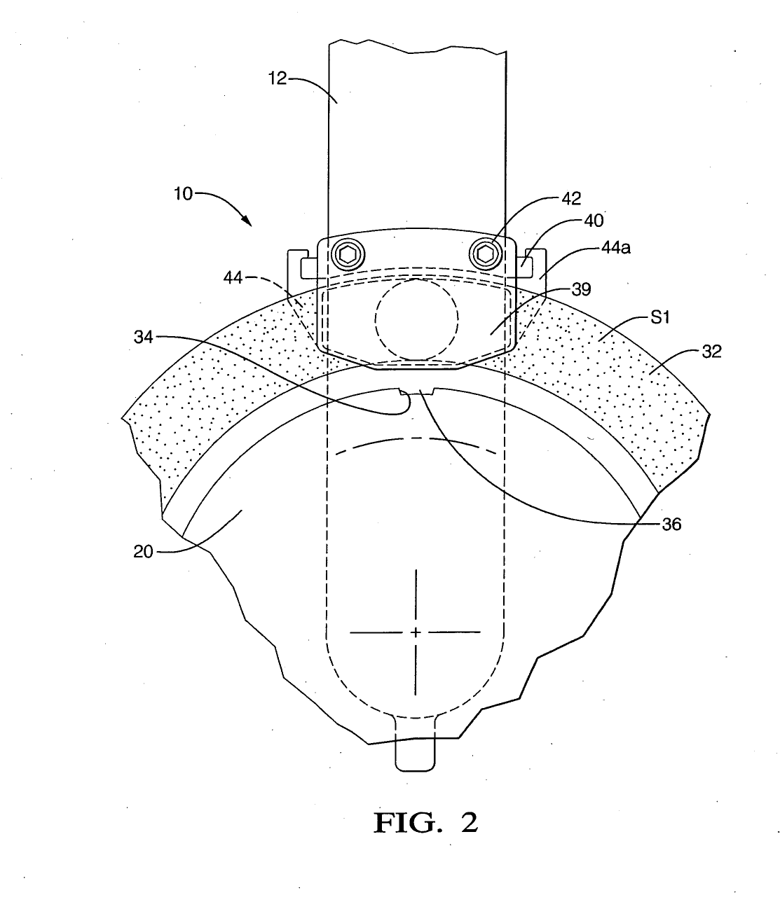

FIG. 2 is a view of a portion of the first illustrative brake system taken in the direction of the arrow II in FIG. 1;

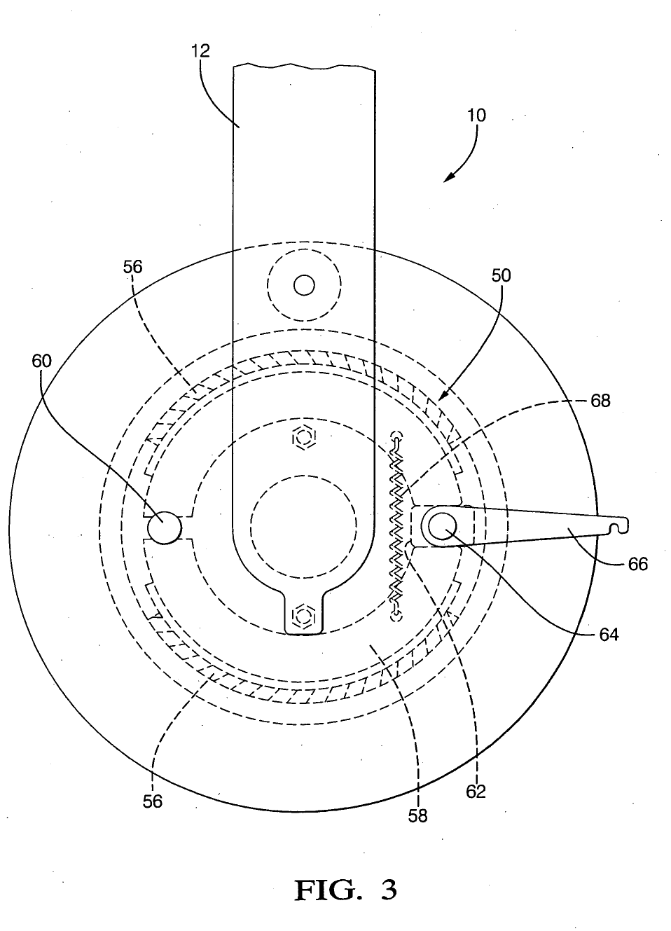

FIG. 3 is a view of a further portion of the first illustrative brake system taken in the direction of the arrow III in FIG. 1; and

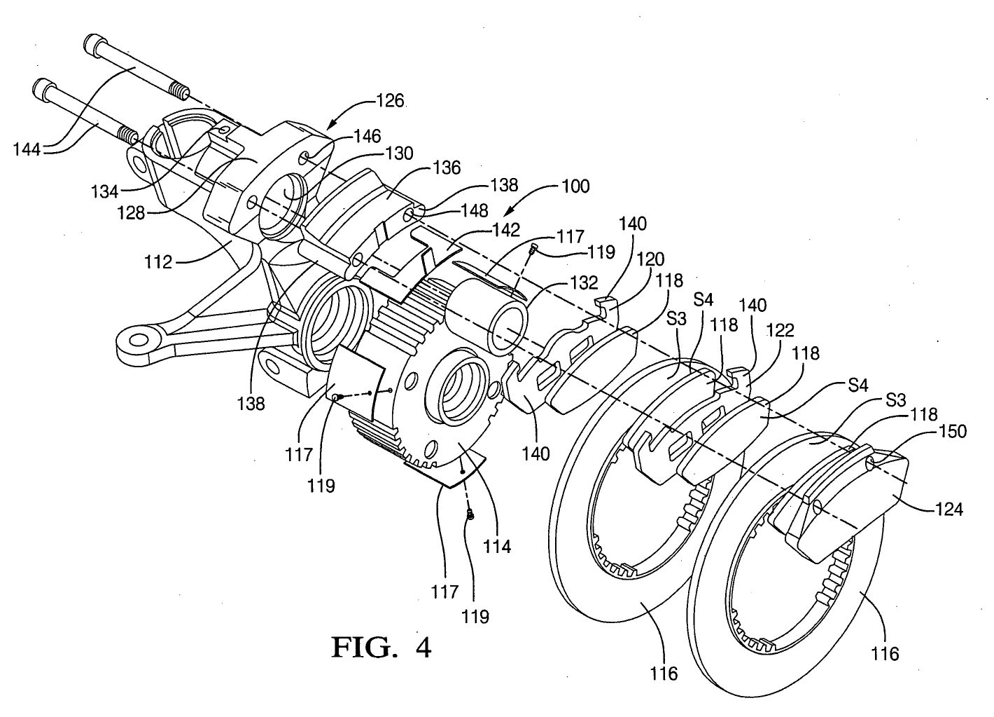

FIG. 4 is an exploded view of a second illustrative brake system.

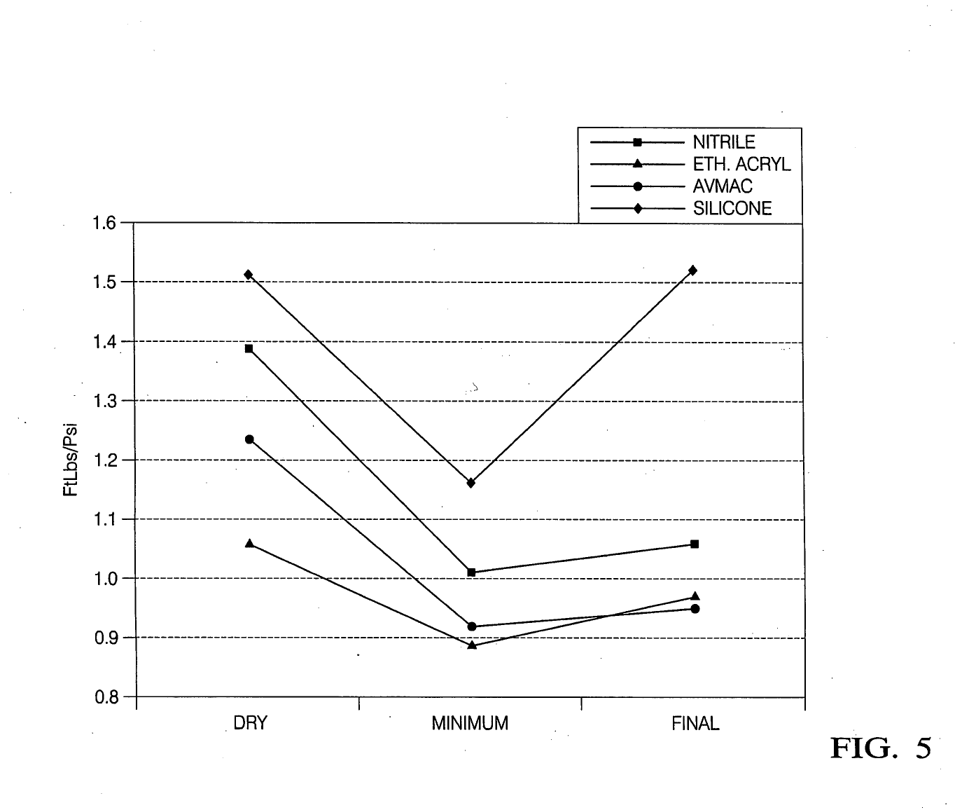

FIG. 5 is a graphical representation of water recovery data relative to the use of various elastomers in additives of the present invention.

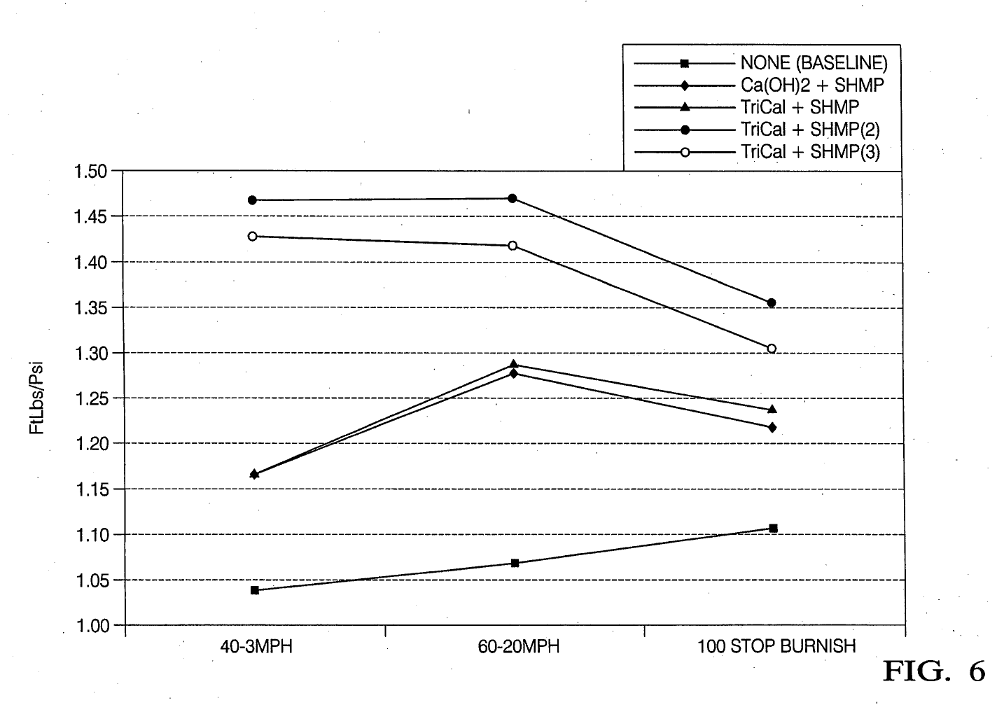

FIG. 6 is a graphical representation of Post Corrosion Torque data relative to various braking regimes when additives of the present invention are integrated within brake pad compositions in accordance with the present invention.

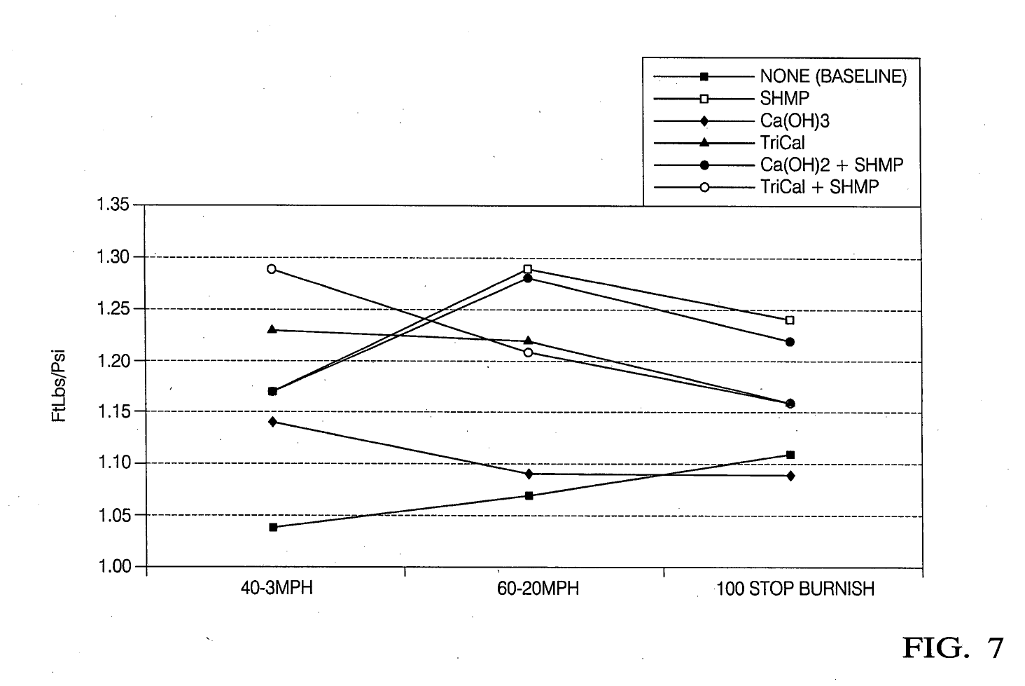

FIG. 7 is a graphical representation of Post Corrosion Torque data relative to various braking regimes, when singular and combined additives are integrated within brake pad compositions in accordance with the present invention.

### DETAILED DESCRIPTION OF THE PRESENT INVENTION

The illustrative brake system 10 shown in FIGS. 1-3 is mounted on a suspension link 12 of a vehicle. On one side thereof, the link 12 has an upper vertical mounting surface 12a and a lower vertical mounting surface 12b (see FIG. 1). A cylindrical recess 14 is formed in the link 12 and has an opening through the surface 12a. The recess 14 has a connection between its bottom surface and a connecting point 16 in the link 12 for a hydraulic pipe (not shown) so that hydraulic fluid under pressure can be delivered to the recess 14 so that (as further described below) the recess 14 can be utilized as the cylinder of a hydraulically-operated piston and cylinder assembly of a disc brake of the system 10. The link 12 also supports a stub axle 18 which extends horizontally from the lower mounting surface 12b.

The illustrative brake system 10 also comprises a hub 20 which is mounted on the stub axle 18 on bearings 22. The hub 20 is mounted for rotation about a central horizontal axis 24 thereof. The hub 20 comprises a central portion 20a which houses the bearings 22, an annular flange portion 20b which extends vertically at one end of the portion 20a, and a mounting portion 20c generally having the shape of a hollow cylinder centered on the axis 24. The flange portion 20b provides an annular vertical mounting surface 20d to which a wheel (not shown) can be bolted by bolts 26 in a conventional manner. The mounting portion 20c is joined to an outer peripheral portion of the flange portion 20b and extends around the central portion 20a.

The illustrative brake system 10 also comprises a disc brake 30 which is generally of the type disclosed in WO 98/25804. The brake 30 comprises two discs 32 which are in the form of annular plates formed of steel. The discs 32 are mounted on the outer surface of mounting portion 20c of the hub 20 so that the discs 32 rotate with the hub 20 about the axis 24 and so that the discs 32 can perform axial sliding movement on the hub 20. Specifically, grooves 34 are formed in the external surface of the mounting portion 20c, each groove 34 extending parallel to the axis 24, and teeth 36 project from the discs 32 into the grooves 34. The teeth 36 serve to transmit rotational forces between the discs 32 and the hub 20 and can slide axially along the grooves 34. As disclosed in WO 98/25804, leaf springs (not shown) provide resilient means acting between the hub 20 and the discs 32 to apply radial force to control the movement of the discs 32.

The disc brake 30 also comprises friction material pads 38 which are mounted on both sides of each of the discs 32. There are four pads 38, these being an outer pad 38 which is mounted on an abutment 39 which is fixed relative to the link 12, two central pads 38 which are between the discs 32 and are mounted for axial movement, and an inner pad 38 (closest to the link 12) which is also mounted for axial movement. Specifically, a caliper 40 is secured to the mounting surface 12a of the link 12 by two bolts 42. The abutment 39 is secured to the caliper 40 by the bolts 42 and the central and inner pads 38 are mounted on supports 44 which are slidable on the outside surfaces of the caliper 40, the central pads 38 being mounted on opposite surfaces of the same support 44. Specifically, the supports 44 have hook-like projections 44a (see FIG. 2) which hook over side surfaces of the caliper 40 which, thus, provides a slideway extending axially.

The disc brake 30 also comprises an operating mechanism operable to bring the pads 38 into contact with the opposite surfaces of the discs 32 so that braking force is applied to the discs 32. The operating mechanism is provided by the aforementioned piston and cylinder assembly which comprises a piston 46 mounted in the recess 14 of the link 12, the recess 14 providing the cylinder of the assembly. The assembly also comprises a sealing ring 48 mounted in a groove in the wall of the recess 14 and engaging the outer surface of the piston 46. When hydraulic fluid under pressure is applied to the connection point 16, the piston 46 is urged out of the recess 14. The piston 46 engages the support 44 of the inner pad 38 and moves it along the caliper 40. The inner pad 38 then engages one of the discs 32 causing it to slide on the hub 20. This disc 32 then engages one of the central pads 38, causing the support 44 of both central pads 38 to move along the caliper 40. The other central pad 38 then engages the other disc 32 and moves it on the hub 20. This disc 32 then engages the fixed outer pad 38 when each disc is actuated.

The illustrative brake system 10 also comprises a drum brake 50 arranged to serve as a parking brake to prevent rotation of the hub 20 when the brake 50 is applied. The drum brake 50 comprises a supporting plate 52 which is bolted to the mounting surface 12b of the link 12 by bolts 54, the plate 52 having a central hole through which the stub axle 18 passes. The drum brake 50 is positioned in the space between the portion 20a of the hub 20 and the internal cylindrical surface 20e of the mounting portion 20c of the hub 20. The drum brake 50 comprises two friction material shoes 56 which are arcuate having convex surfaces which face the surface 20e of the mounting portion 20c. The shoes 56 are mounted on arcuate supports 58 which are pivotal at one end thereof on a horizontal pin 60 supported by the plate 52. The other end of each of the supports 58 engages a cam 62 which is arranged to be turned about a horizontal pin 64 by operation of a lever 66. The pin 64 is supported by the plate 52 and the lever 66 projects through a space between the plate 52 and the mounting portion 20c of the hub 20. The supports 58 are arranged so that they leave sufficient space between them for the portion 20a of the hub 20. The cam 62 has a shorter radial extent which engages the supports 58 when the drum brake 50 is in an inoperative condition but, by operation of the lever 66, can be turned into an operative condition in which a larger radial extent of the cam 62 engages the supports 58. A spring 68 acts between the supports 58 to keep them in contact with the cam 62. In moving from the inoperative condition to the operative condition thereof, the cam 62 pivots the supports 58 about the pin 60, thereby moving the shoes 56 apart and into engagement with the surface 20e of the mounting portion 20c of the hub 20 so that the drum brake 50 acts as a parking brake.

As shown in FIG. 1, a surface S1 engages or interfaces with a mating surface(s) S2 of the calipers or brake shoes upon activation of the brakes. The system is described in co-owned U.S. Pat. No. 6,484,852, herein incorporated by reference. It will be appreciated that each time the brake system is activated, the surface S1 is slightly worn thereby subjecting the surface to corrosion if not properly protected. In accordance with the present invention, the second surface S2 is worn at each application of the brakes thereby imparting a coating C1 over the surface S1 as described herein, thereby protecting the resultant underlying surface S1.

Yet another exemplary brake system is illustrated in FIG. 4. As described in U.S. Pat. No. 6,298,953, herein incorporated by reference, the illustrative disc brake 100 is mounted on a suspension link 112 of a vehicle. The suspension link 112 has a hub 114 mounted for rotation thereon. A wheel (not shown) is mounted on the hub in the usual manner. The brake 100 also comprises two discs 116 which are mounted on the hub 114 for axial sliding movement. Specifically, the outer surface of the hub 114 has three circumferentially-spaced surface portions which are formed with axial splines and the discs 116 are formed with teeth which mesh with these splines so that the discs can slide axially on the hub but rotate therewith. The hub 114 has three leaf springs 117 secured thereto by screws 119. The leaf springs 117 are arranged on the surface portions of the hub between the splines thereof and serve to centralize the discs 116 and to prevent them from rattling on the hub.

The brake 100 also comprises friction material pads 118 arranged on opposite sides of each of the discs 116. Specifically, one of the friction pads 118 is mounted on a backing plate 120 on one side of a first of the discs 116, two of the pads 118 are mounted on opposite sides of a backing plate 122 which is between the first and the second discs 116, and one of the pads 118 is mounted on an abutment 124 on an opposite side of the second disc 116 to the backing plate 122.

The brake 10 also comprises an operating mechanism 126 operable to move the pad 118 on the backing plate 120 into contact with the first disc 116. The mechanism 126 is also affective to cause relative movement between the mechanism 126 and the discs 116 to bring the other pads 118 mounted on the backing plate 122 and the abutment 124 into contact with the discs so that the pads all apply a braking force to the discs. Specifically, movement of the pad 118 on the backing plate 120 into contact with the first disc 116 causes the first disc 116 to slide on the hub 114 into contact with one of the pads 118 on the backing plate 122, continued movement brings the other pad 118 on the backing plate 122 into contact with the second disc 116 which, in turn, slides on the hub 114 until the second disc 116 contacts the pad 118 on the abutment 124.

The operating mechanism 126 comprises a support body 128 which is located on one side of the first disc 116. The support body 128 is provided by a portion of the link 112. The operating mechanism 126 also comprises a cylinder 130 defined by the support body 128, and a piston 132 in the cylinder. The piston 132 is movable, when fluid under pressure is introduced into the cylinder 130 through a port 134 to move out of the cylinder and thereby urge the backing plate 120 and the pad 118 mounted thereon towards the first disc 118.

The operating mechanism 126 also comprises a guidance member 136 projecting from the support body 128 past the discs 116. The guidance member 136 supports the abutment 124. The backing plates 120 and 122 and the pads mounted thereon are mounted for sliding movement on the guidance member 136. Specifically, the guidance member 136 has two arcuate side surfaces 138 on which the plates 120 and 122 slide. The plates 120 and 122 having upper hook portions 140 which hook over the surfaces 138 so that the plates 120 and 122 are supported by the member 136 and can slide along the member 136. A leaf spring 142 is-provided between the underside of the member 136 and the plates 120 and 122, the spring 142 serving to prevent rattling.

The guidance member 136 of the operating mechanism 126 is mounted on the support body 128 by means of a two high tensile bolts 144 which pass through bores 146 in the support body 128 and bores 148 in the guidance member 136 to enter threaded bores 150 in the abutment 124.

In the operating mechanism 126, introduction of hydraulic fluid under pressure into the cylinder 130 causes the piston 132 to urge the pads 118 into contact with the discs 116 as aforementioned. When this contact has been achieved braking forces between each of the pads 118 and the discs 116 are transmitted to the member 136 via the backing plates 120 and 122 and the abutment 124. However, the high bending and shearing forces applied thereby to the guidance member 136 is taken by the bolts 144.

As shown in FIG. 4, and in accordance with the present invention, a third surface S3 interfaces with a complementary set of brake shoes or liners. It will be appreciated that each time the brake system is activated, the surface S3 is slightly worn thereby subjecting the surface to corrosion if not properly protected. Accordingly, a fourth surface(s) S4 of an adjacent brake shoe or brake pad imparts a phosphate coating to S3 upon application of the brakes and wear at the interface of the rotor and the brake pad. Accordingly, in accordance with the present invention, as the brake shoe is worn, a metallic phosphate coating may be formed on each adjacent surface S3 and S4 thereby protecting the resultant underlying surfaces.

It should be noted that other brake assemblies are also contemplated in accordance with the present invention and include, but not by way of limitation, those described in U.S. Pat. Nos. 6,640,937, 6,508,338, 6,860,368, and 6,508,340, herein incorporated by reference.

The components of the brake assembly may be fabricated in a known manner from standard gray cast iron, steel, aluminum, or other material, alloy, or composite. Brake component applications include rotors, drums, disc brake pads, and other surfaces that experience sliding frictional motion.

In accordance with the present invention, an additive for integration within a typical brake pad/lining composition, and a brake assembly formed with a brake pad containing the additive, is provided. The brake pad/lining may be otherwise formed as known in the art. U.S. Pat. Nos. 5,641,444 and 5,261,512 herein incorporated by reference, exemplify but do not limit typical brake shoe or brake pad/lining manufacture. As described in U.S. Pat. No. 5,641,444, the various constituents of the brake pad may be wet or dry mixed together in a mixer, and stirred to form a uniform, or substantially homogeneous mixture. The mixture may then be pelletized, if desired, in a disk pelleter made by Fuji Paudal for example, to form pellets having a diameter ranging from 0.1 to 3 mm, again for illustration only. The pellets, or the unpelletized mixture, may then be fed into a mold such as an extruding plate wherein the plate is heated to a temperature between 60 C to 120 C, for example, under typical operating pressures such as 1 to 100 kg/cm².

An exemplary liner or brake pad composition may contain, as described in U.S. Pat. No. 4,994,506 incorporated herein by reference, a resin such as a phenolic resin, and fillers such as graphite, carbonaceous materials, rubber particles, barium sulfate, silicas, aluminum oxide, clays, calcium carbonate, steel fiber, brass, aluminum, zinc in form of fibers, chips, wool, copper powder, sponge iron, aramide fiber, calcium sulfate whiskers, and similar additives. Other additives include friction modifiers such as cashew nut resin and dust; friction controllers such as carbonaceous materials; abrasive modifiers such as alumina and kyanite having a particle size less than 75 micrometers; noise and/or wear controllers such as rubber particles, carbonaceous materials, ground limestone, barites, clays, micas, glass fibers, and finely divided silicas; fade controllers such as zinc chips and aluminum chips; and mixtures thereof. These are provided in known effective amounts and mixed prior to melt forming as known in the art. It should be appreciated therefore, that any additives typically employed in brake liner/pad compositions are contemplated in accordance with the present invention. Therefore, known constituents of brake pads/linings may be combined in known effective amounts with the additives of the present invention, thereby resulting in one or more benefits including one or more of those benefits described herein.

Additives of the present invention are formed from an elastomer and a corrosion inhibitor, the corrosion inhibitor including at least one water-soluble phosphate. The elastomer is provided at about 40-95% by volume and the corrosion inhibitor (that is, at least one water-soluble phosphate and if desired a base or a water-insoluble phosphate) is provided at about 5-60% by volume, the volume percents stated by volume of the additive. The elastomer is selected from any elastomeric compound including fluoroelastomers, silicones, ethylene/acrylate polymers provided by Dupont™ under the tradename Vamac®, ethylene-N-butyl-acrylic carbon monoxide (ENBACO), nitrile rubbers, butadiene rubbers, styrene-butadiene rubbers, and carbon black rubbers. Silicones also exhibit hydrophobic properties, and when integrated into the brake lining/pad compositions, water is naturally repulsed in the presence of the hydrophobic silicones thereby providing a corrosion prevention benefit. It is also believed that the majority of known friction materials, as described in U.S. Pat. No. 4,722,950, herein incorporated by reference, have some elastomer content. Typically, the elastomer is provided in a ground crumb having a diameter of about 0.1 to 2 mm, and at a volume fraction of 2-10% within the brake pad. Examples include ground scrap tire peel, nitrile rubber, styrene-butadiene rubber, butadiene rubber, or carbon black, nitrites, silicones, and ethylene acrylics. The elastomers are employed to introduce the inhibitors to the lining/rotor interface in a controlled manner.

The ENBACO and silicone families of elastomers typically possess high filler capacity (e.g. high corrosion inhibitor capacity), good to exceptional temperature resistance, chemical resistance to the inhibitors in question, and are extremely hydrophobic. All of these qualities make these particular elastomers preferred when determining what elastomer to employ in the additives of the present invention. Pre-compounding elastomers with inhibitors will isolate them from the uncured phenolic during molding, and permit a continuous, controlled metering of inhibitors to the brake wear surface even after repeated exposure to water during service (i.e. rain, car washes, etc). Grinding the pre-compound to particles greater than about 0.5 mm reduces the surface area and therefore the amount of inhibitor available to dissolve/react with resin thereby permitting normal processing of the friction material.

The corrosion inhibitor includes at least one water-soluble phosphate including alkaline earth or alkali metal phosphates such as sodium hexametaphosphate (SHMP), tri-sodium phosphate (TSP), di-sodium phosphate (DSP), di-sodium polyphosphate (DSPP), tri-sodium polyphosphate (TSPP), and sodium pyrophosphate acid. If desired, an additional water-insoluble phosphate such as tri-calcium phosphate, or an oxide or hydroxide such as an alkaline earth or alkali metal hydroxide including calcium hydroxide may also be added. Or, stated another way, a water-soluble phosphate is included as a corrosion inhibitor and preferably functions as a pH modifier once liberated from the brake pad composition due to wear at the rotor/brake lining interface.

The corrosion inhibitor may also include at least one base selected from the group including alkaline earth and/or alkali metal hydroxides and oxides such as calcium hydroxide. Calcium hydroxide is known for its usefulness as a hardness modifier. However, when mixed within the brake pad resin, calcium hydroxide functions as a curing catalyst and thereby detrimentally causes curing at an undesirable accelerated rate. Encapsulation within the elastomers of the additive inhibits the catalytic effect of calcium hydroxide thereby facilitating the use of calcium hydroxide without the detrimental curing acceleration. The corrosion inhibitor may also optionally include water-insoluble phosphates such as tri-calcium phosphate.

Examples of typical corrosion inhibitors formed from more than one of the corrosion inhibitor constituents include SHMP and calcium hydroxide, and SHMP and tri-calcium phosphate. The SHMP and the tri-calcium phosphate may be separately added to the elastomer, or to the brake pad composition, in the volumetric percentages described above, when considered in combination with each other.

As the encapsulated inhibitor wears against the rotor surface, it becomes liberated from the elastomer by both abrasion and thermal degradation of the elastomer. As the inhibitors are by design thermally stable, the concentration of these phases becomes enriched on the rotor and pad wear surfaces as they become part of the pad and rotor transfer film(s). In the presence of moisture, it is believed that the hydroxyl ions raise the pH of the water at the rotor/lining interface to help passivate the rotor wear surface. Simultaneously, it is believed that the solubilized phosphate ions react with the rotor metal to form an iron phosphate film, interfering with the transfer of electrons of any potential galvanic cell.

The elastomer(s) and the corrosion inhibitor(s) are formed by wet or dry mixing the constituents together in a mixer, preferably at room temperature to inhibit any curative reaction. The mixture may then be sheeted out wherein heat is then applied to either partially or completely cure the mixture. The partially cured or cured mixture is then ground to a desirable particle size and integrated into a brake pad through the brake pad molding/manufacturing process. The additive is combined within the brake pad at about 1-10 weight percent of the total lining/brake pad composition, and more preferably at about 4-6 weight percent, and more preferably at about 5 weight percent of the total composition. The metal phosphates of the present invention may be provided by any known supplier such as Coasty, Corp. of Canada, or Rhodia of France. The metal hydroxides or oxides may be supplied by known suppliers including Mississippi Lime Corporation of St. Louis, Mo. The elastomers may be provided by known suppliers as well. The silicones may be provided by General Electric or Dow Corning, and the fluoroelastomers may be provided by Dupont, for example.

The efficacy of the corrosion protection may be determined by testing defined by ASTM B117, and the composition of the additive may be iteratively adjusted based on design requirements. By selecting hydrophobic elastomers, and incorporating them into the friction material, the amount of water absorbed by the molded lining can be significantly reduced. Water recovery is therefore improved as shown in FIG. 5. The hydrophobic character, in combination with the incorporated inhibitors, is believed to create a synergistic effect that significantly reduces corrosion buildup beneath the brake pads.

It is also believed that the use of the additive and the associated results may be described as follows. As understood from basic aqueous corrosion theory, it is possible to reduce or eliminate corrosion by varying the pH of the aqueous metal interface. This is referred to as passivation of the galvanic couple. In the case of iron in water, adjusting the pH from an acidic or neutral level to a basic level (between 11 and 12, for example) results in the desired metal passivation. In accordance with the present invention, the alkalinity resulting from dissolution of the corrosion inhibitor within the moisture present at the rotor/pad interface, and particularly dissolution of the alkali metal phosphates, results in a localized increase at that interface thereby passivating the adjacent metal surfaces of the rotor and brake pad. With regard to the brake pad/liner composition, one way to introduce a pH modifier, e.g. a metal water-soluble phosphate, a metal water-insoluble phosphate, or an alkali or alkaline earth metal hydroxide, is to directly add it to the friction material. Preferred corrosion inhibitors or pH modifiers are non-abrasive and temperature insensitive, and exhibit low solubility thereby inhibiting the complete loss or “leaching out” when immersed in water. Calcium hydroxide meets all of these requirements. It has a pH of about 12.4, hardness significantly lower than cast iron, thermal stability up to 1580 C, and a solubility of about 0.0016 g/ml in water. It is also inexpensive and readily available with very low impurities and a very fine particle size. Only a minimal addition, typically less than 5 vol %, is necessary to raise the pH of an exemplary friction material to the preferable range of between 11 and 12, although passivation may occur at lower basic pH levels. Because calcium hydroxide quickens the curing of phenolic resins typically used in brake liners, it detrimentally affects the manufacture of brake pads if employed therein.

### EXAMPLE 1

Water-insoluble phosphates, such as tri-calcium phosphate, were encapsulated in an elastomer as described above, and then added at about 1-10 weight/o to a general brake pad composition and processed in a known manner. The water insoluble phosphates were determined to be ineffective as corrosion inhibitors based on standard corrosion tests, ASTM B117 for example.

### EXAMPLE 2

Water-soluble phosphates, such as SHMP, sodium pyrophosphate acid, and sodium tripolyphosphate (STPP) when encapsulated in at least one elastomer as described above, and then included within a brake pad composition as it was manufactured, produced significant aqueous corrosion protection on cast iron. These phosphates were found to reduce corrosion singularly, or in combination with any of the others, or when combined with calcium hydroxide. Tests were conducted on rotors that were “coated” by application of brakes and by the subsequent wear of brake pads containing one or more of these constituents within a molded composition. The rotor was coated by wear of the break pad, and by concurrent filming or coating of the rotor as the brakes were actuated. The phosphates of this example were found to be nonabrasive, thermally stable in air up to 900 C, effective at relatively low concentrations within the brake pad, and relatively inexpensive.

### EXAMPLE 3

To facilitate the use of calcium hydroxide but still insulate the calcium hydroxide from the uncured resin during mixing and/or molding, and to also provide a slow release of the chemical at the rotor/lining interface, calcium hydroxide was encapsulated in low-density polyethylene or other thermoplastic binders. Thermoplastics were determined to melt or decompose during molding, post-curing, and in-situ during vehicle braking. Accordingly, parts associated with thermoplastics were determined to be weakened due to poor friction and wear characteristics. Accordingly, the use of thermosets rather than thermoplastics as an additive elastomer is preferred.

### EXAMPLE 4

Calcium hydroxide was encapsulated in a hydrophobic elastomer of the present invention as a pre-form to form an additive in accordance with the present invention. The additive was then included in a composition of several brake pads as they were molded during manufacture. The pads were burnished and then clamped to a rotor and exposed to cyclical three-day salt spray/humidity/drying corrosion schedule (DM892). All pads containing 0.8 to 3.3 volume % calcium hydroxide adhered so strongly to the rotor that they could not be pried from the rotor without leaving large pieces of lining material still bonded to the rotor surface. It was also determined that even at a pH of 12, calcium hydroxide as a singular corrosion inhibitor was ineffective.

### EXAMPLE 5

Rotors and pads were painted directly with a solution of water-soluble phosphate and calcium hydroxide. The rotors were exposed to a 5 wt % salt solution. Corrosion protection was found at about 0.6 wt % of corrosion inhibitor in solution. As the percent of corrosion inhibitor was increased, corrosion protection was improved. At about 3-5 wt %, the corrosion inhibition remained about the same. A complete prevention of pad crevice corrosion was observed when the same inhibitor solution was applied directly to the rotor or pad surface. The inhibitor concentration required to reduce or prevent crevice corrosion beneath a brake pad clamped to a rotor surface wherein the rotor surface is painted directly prior to clamping to the pad, is higher than the concentration for the exposed rotor surface. It should further be emphasized that the required concentration of inhibitors encapsulated into the brake pad is greater than for inhibitor solution painted directly on the rotor surface, and greater yet for prevention of crevice corrosion at the rotor/lining interface. When employed within a liner composition, greater than 3 vol % of the water-soluble phosphate and greater than 3 vol % of hydroxide, as encapsulated within a hydrophobic elastomer, is required to reduce/eliminate the corrosion on the exposed rotor and the crevice corrosion typically occurring at the rotor/pad interface.

### EXAMPLE 6

The addition of an additive of SHMP and sodium pyrophosphate acid, at 3 vol % each, to a brake pad composition in accordance with the present invention, resulted in a stabilization of the friction properties of the brake pad as measured by dynamometer. In particular, the standard deviation of coefficient of friction (mu) was reduced by up to 40%.

### EXAMPLE 7

When otherwise identical brake pad formulations were burnished and evaluated on the aforementioned corrosion recovery schedule DM892 (See Example 4), there was a 22-26% loss in friction even after 200 dynamometer stops for all formulations containing one of the following additives:

a. 0.8 to 3 vol % hydroxide;

b. up to 3 vol % water-soluble phosphates including SMP and sodium pyrophosphate acid;

c. up to 3 vol % insoluble tri-calcium phosphate; or

d. 0 vol % inhibitor control.

When a hydrophobic elastomer compounded with 3 vol % each hydroxide and soluble phosphate(s) was combined in a brake pad, the resulting output loss was only 9%. Uncompounded tri-calcium phosphate showed similar low output loss.

### EXAMPLE 8

Silicone and ENBACO elastomers, when compounded within a brake pad composition at the same level as typically used with state of the art linear nitrile rubber, resulted in post-cured/ground brake pads much more hydrophobic. Water would bead on the surface of the pad and slowly evaporate instead of being rapidly absorbed by the pad. This also reduced pad adhesion to the rotor. The use of silicone results in relatively better thermal stability. The use of silicone also results in increased friction after water exposure by up to 40% as compared to pads using linear nitrile and also as compared to pads using ENBACO elastomer families.

### EXAMPLE 9

Encapsulating the hydroxide reduced the amount available to react with the phenolic resin by as much as an order of magnitude, that is one tenth, when compared to an unencapsulated amount. Pads containing up to 4 vol % encapsulated calcium hydroxide could be molded without any deviation in molding parameters. When calcium hydroxide is employed without being encapsulated in an elastomer of the present invention, a large reduction in mold temperature, a corresponding increase in molding time, and several more vent cycles were necessary to prevent the pad containing un-encapsulated hydroxide from cracking. Pads containing greater than 3 vol % of a straight addition of hydroxide could not be successfully molded.

### EXAMPLE 10

As shown in FIG. 5, brake pads containing an additive formed from a corrosion inhibitor and an elastomer selected from nitrile, ethylene acrylate, VAMAC®, or silicone were tested with regard to water exposure. As known in the art, brake pads are typically porous and therefore retain water. Application of the brakes after water exposure may affect the frictional properties of the pad as shown in the graph. The silicone is any silicone commercially available with heat resistant properties. As shown in the graph, when silicone was employed as an elastomer, the frictional loss was less than what occurred with the other elastomers. Additionally, the silicone recovered to full frictional properties whereas the other pads exhibited a continued frictional loss. A dynamometer was used to measure the associated torque, and the frictional properties, upon braking at dry, wet (minimal friction), and final conditions.

### EXAMPLE 11

As shown in FIG. 6, several brake pads containing corrosion inhibitors of the present invention were compared to a brake pad without any corrosion inhibitor contained therein. All brake pads were subjected to corrosive conditions as prescribed by ASTM B117. It can be seen that the use of a corrosion inhibitor functions to control corrosion as well as frictional loss due to corrosion.

### EXAMPLE 12

As shown in FIG. 7, several brake pads containing corrosion inhibitors of the present invention were compared to a brake pad without any corrosion inhibitor contained therein. Additionally, corrosion inhibitors containing either an hydroxide or a phosphate were compared to combination corrosion inhibitors containing both an hydroxide and a phosphate, or, containing a water-soluble phosphate and a water-insoluble phosphate. All brake pads were subjected to corrosive conditions as prescribed by ASTM B117. It can be seen that the use of a corrosion inhibitor functions to control corrosion as well as frictional loss due to corrosion.

In yet another aspect of the invention, a method of preventing corrosion within a brake assembly is provided. A brake pad is manufactured as described above. Upon brake activation, the brake pad imparts the corrosion inhibitor dispersed therein onto the wear surface of the rotor at the rotor/pad interface. The heat inherent in the application of the brakes functions to basically bake the corrosion inhibitor or reactants thereof, such as iron phosphate, onto the surface of the rotor at each application of the brake. In essence, at each application of the brakes, the brake pad wears to provide corrosion inhibitor thereby providing a continual time release of corrosion inhibitor onto the adjacent rotor surface for filming thereon.

While specific embodiments of the instant invention have been described in detail, those with ordinary skill in the art will appreciate that various modifications and alternatives to those details could be developed in light of the overall teachings of this disclosure. Accordingly, the particular arrangements disclosed are meant to be illustrative only and not limiting as to the scope of the invention, which is to be given the full breadth of the appended claims and any and all equivalents thereof.

We claim:

1. A brake assembly comprising:
a first component constructed of a metal;
at least one surface on said first component; and
a second component comprising a water-soluble phosphate, said second component further containing a second surface adjacent to said at least one surface,
wherein said at least one surface and said second surface are wear surfaces.

2. The brake assembly of claim 1 wherein said second component further comprises a base selected from alkali and alkaline earth metal hydroxides and oxides.

3. The brake assembly of claim 1 wherein said second component further comprises a water-insoluble phosphate.

3. The brake assembly of claim 1 wherein the first component is a rotor and the second component is a brake pad.

4. The brake assembly of claim 3 comprising a plurality of rotors and a plurality of brake pads.

5. The brake assembly of claim 1 wherein the corrosion inhibitor is formed from a water-soluble phosphate and an elastomer for encapsulation of the water-soluble phosphate.

6. The brake assembly of claim 5 wherein the water-soluble phosphate is selected from sodium hexametaphosphate, tri-sodium phosphate, di-sodium phosphate, di-sodium polyphosphate, tri-sodium polyphosphate, sodium pyrophosphate acid, and mixtures thereof.

7. The brake assembly of claim 1 wherein the second component comprises sodium hexametaphosphate, tri-calcium phosphate, and silicone, each constituent substantially homogeneously dispersed within said second component.

8. The brake assembly of claim 5 wherein the water-soluble phosphate when combined with the elastomer comprise about 1-10 wt % of the total weight of the second component wherein the second component is a brake lining.

9. A brake pad containing an additive wherein the additive comprises a water-soluble phosphate, and an hydrophobic elastomer for encapsulation of said water-based phosphate.

10. A brake assembly containing the brake pad of claim 9.

11. A method of coating a first rotor surface of a brake assembly, said method containing the steps of:
providing an additive formed from a phosphate, a base selected from an hydroxide and an oxide, and an elastomer for encapsulation of the phosphate and the base;
manufacturing a brake pad by molding a brake pad composition containing the additive;
manufacturing a brake assembly including at least the brake pad and a second component, the brake pad and the second component having adjacent wear surfaces forming an interface;
activating the brake assembly to force the pad against the second component; and
imparting a coating on the second component by wearing the brake pad thereon as the brake assembly is activated.

12. The method of claim 11 wherein said second component is a brake rotor.

13. A composition containing:
a water-soluble phosphate; and
an hydrophobic elastomer for encapsulation of said water-soluble phosphate.

14. The composition of claim 13 further comprising a water-insoluble phosphate.

15. The composition of claim 14 wherein said water-insoluble phosphate is tri-calcium phosphate.

16. The composition of claim 13 wherein said water-soluble phosphate is selected from sodium hexametaphosphate, tri-sodium phosphate, di-sodium phosphate, di-sodium polyphosphate, tri-sodium polyphosphate, sodium pyrophosphate acid, and mixtures thereof.

17. The composition of claim 13 wherein said hydrophobic elastomer is selected from silicones, fluoroelastomers, ethylene/acrylate polymers and copolymers, ethylene-N-butyl-acrylic carbon monoxide, nitrile rubbers, butadiene rubbers, styrene-butadiene rubbers, and carbon black rubbers.

18. The composition of claim 13 wherein said hydrophobic elastomer is provided at about 40-95 volume % of the total composition, and the water-soluble phosphate is provided at about 5-60 volume % of the total composition.

19. The composition of claim 18 further comprising a base and/or a water-insoluble phosphate wherein said base and/or said water-insoluble phosphate when combined with said water-soluble phosphate are provided at about 5-60 volume % of the total composition.

20. A brake lining comprising the composition of claim 13 wherein said composition comprises about 1-10 weighted of the total weight of the brake lining.
